(19) United States
(12) Patent Application Publication
(10) Pub. No.: US 2023/0266979 A1
(43) Pub. Date: Aug. 24, 2023

(54) METHOD AND SYSTEM FOR MAXIMIZING RESOURCE UTILIZATION AND USER EXPERIENCE FOR A POOL OF VIRTUAL DESKTOPS

(71) Applicant: Workspot, Inc., San Jose, CA (US)

(72) Inventors: Shiva Prasad Madishetti, San Jose, CA (US); Anushree Kunal Pole, San Jose, CA (US); Edward A. Seidman, San Jose, CA (US); Amitabh Bhuvangyan Sinha, San Jose, CA (US); David T. Sulcer, San Jose, CA (US); Lisa Wing San Chui, San Jose, CA (US); Jimmy Chang, San Jose, CA (US); Virabrahma Prasad Krothapalli, San Jose, CA (US); Raminder Channe, San Jose, CA (US)

(21) Appl. No.: 17/678,777

(22) Filed: Feb. 23, 2022

(51) Int. Cl. G06F 9/451

(52) U.S. Cl. CPC G06F 9/452

(57) ABSTRACT

A system and method for optimizing compute resources for virtual desktops in a cloud based virtual desktop system is disclosed. The desktop system provides access to virtual desktops by remote devices. The virtual desktops consume compute resources. A compute resource optimization service communicates with a client on the remote display device. A virtual desktop having an agent is in communication with the resource optimization service. A virtual infrastructure system is in communication with the compute resource optimization service. The compute resource optimization service optimizes allocation of the compute resources to the virtual desktop from the virtual infrastructure system by setting the virtual desktop in one of a plurality of states.

### TECHNICAL FIELD

The present disclosure relates generally to network-based systems. More particularly, aspects of this disclosure relate to a system that maximizes resource utilization for a system having a pool of virtual desktops.

### BACKGROUND

Computing systems that rely on applications operated by numerous networked computers are ubiquitous. Information technology (IT) service providers thus must effectively manage and maintain very large-scale infrastructures. An example enterprise environment may have many thousands of devices and hundreds of installed software applications to support. The typical enterprise also uses many different types of central data processors, networking devices, operating systems, storage services, data backup solutions, cloud services, and other resources. These resources are often provided by means of cloud computing, which is the on-demand availability of computer system resources, such as data storage and computing power, over the public internet or other networks without direct active management by the user.

Users of networked computers such as in a cloud-based system may typically log into a computer workstation or client device and are provided a desktop application that displays an interface of applications and data available via the network or cloud. Such desktop applications will be initially accessed when a user logs in, but may remain active to respond to user operation of applications displayed on the desktop interface. While users may activate the desktop application on any computer on the network, most users work from one specific computer.

Because physical desktops cannot be dynamically modified as needs change, their users must usually be allocated a hardware class sufficient to handle the application scenario's peak performance requirement, even though that requirement is often the exception and not the rule. For example, each desktop user will be allocated a dedicated physical machine that is continuously available to that user, for 7×24 hours of the week. The cost of the hardware resources is constant, and therefore there is significant over-provisioning and wasted cost.

Remote desktop virtualization solutions have been available for over a decade. These solutions provide virtual desktops to network users. In remote desktop virtualization offerings, there is typically a capability of associating a remote desktop virtualization template in a particular datacenter with a remote desktop virtualization pool in the same datacenter as part of the general configuration model. This remote desktop virtualization template is customized with the image of the right desktop for a particular remote desktop virtualization use case.

A global virtual desktop service system includes a large number of desktop service resources, including many virtual machines, virtual networks, and other services. There are numerous dependent components of a global desktop service system. Such dependent components may include installed client software, endpoint client devices, the network used by the endpoint client devices, cloud APIs provided to manage virtual desktop infrastructure globally, regional resources utilized by cloud infrastructure providers, such as networks, gateway hosts, the virtual desktop hosts, agent services, the virtual desktop operating system, and computing, storage, and network services provided by the cloud infrastructure provider.

An application scenario and its operating system environment are run on certain desktop hardware components, which may be physically co-located with the user, or may be “virtual machines” that are accessed remotely and/or indirectly by a service provider. In the case of virtual machines, the physical hardware involved may be a different solution that emulates the physical machine attributes expected by the user. Virtual machines are employed in many different industrial uses, such as web services that respond to requests constantly. Application scenarios for virtual desktops, more specifically, are designed for individual users interacting with desktop software. In fact, these application scenarios may utilize compute resources sporadically, may rarely require peak operational performance, and are often completely idle. Typically, a desktop user only requires the applications for some duration of time during a work day. It is possible that the desktop will perform background processing without user interaction; however, for some hours of the day, the desktop is generally unused.

As an application scenario is used, the consumption of hardware compute resources varies over time for each desktop user. Some operations consume more CPU or GPU resources; others consume more RAM memory. Some are long operations, and some very short. The following diagram illustrates the consumption of compute resources for a single user over the course of a week, for a specific hardware class. Simply replacing physical machines with virtual machines does not in itself solve this, because they are typically provisioned and managed in such a way that they are still statically maintained, and the cost of hardware compute resources is therefore still constant.

For example, a graph of CPU and memory use for a virtual desktop over a period of time, such as a week, will show wasted periods of compute resource consumption such as times when the user is not even connected to the virtual desktop. Because of the lack of resource optimization, many virtual desktop service systems face similar costs to physical hardware provisioning, without an optimization solution.

Thus, there is a need for a service for a virtual desktop system that optimizes resource use by determining idle times and allows pausing of virtual desktops during such times. There is also a need for a service that has different states for a virtual desktop based on stored policies for optimal resource use.

### SUMMARY

One disclosed example is a system for a virtual remote desktop system providing remote devices access to virtual desktops. The virtual desktops consume compute resources. The system includes a compute resource optimization service communicating with a client on a remote device. The system includes a virtual desktop having an agent in communication with the resource optimization service. A virtual infrastructure system in communication with the compute resource optimization service. The compute resource optimization service optimizes allocation of the compute resources to the virtual desktop from the virtual infrastructure system by setting the virtual desktop in one of a plurality of states.

A further implementation of the example system is an embodiment where the plurality of states includes a paused state. Another implementation is where the paused state includes one of suspending a virtual machine associated with the virtual desktop, powering down the virtual machine. or de-allocating the virtual machine. Another implementation is where the plurality of states further includes a resuming state, a disconnected state, and a connected state. Another implementation is where the plurality of states includes an error handling state. Another implementation is where a transition to the pause state from another state occurs via one of explicit logout, explicit disconnect or a protocol idle connection timeout. Another implementation is where the system includes a storage device storing a policy accessible by the compute resource optimization service. The policy determines the transition to the one of the plurality of states of the virtual desktop in response to events. Another implementation is where the policy is one of a plurality of policies, each of the plurality of policies determining a different allocation of compute resources to the virtual desktop. Another implementation is where the virtual desktop is a member of a pool of virtual desktops, and wherein the policy is applied to each virtual desktop in the pool. Another implementation is where one of the plurality of states is a pause state designated as a normal state for the virtual desktop. Another implementation is where the policy is a configurable policy allowing the specification of a delay period that follows a disconnection before a pause automatically occurs. Another implementation is where the policy is a configurable policy allowing the specification of a period of work hours where the virtual desktop is not paused. Another implementation is where the optimization service includes the capacity to pause the virtual desktop by reallocating the compute resources when the virtual desktop is idle. Another implementation is where the reallocation of the compute resources is made to at least one other user of another virtual desktop in a different time zone than the user. Another implementation is where a period of time for pausing the virtual desktop is determined from a previous pattern of use of the virtual desktop by the user. Another implementation is where a period of time for pausing the virtual desktop is determined from a schedule associated with the user of the virtual desktop. Another implementation is where the optimization service includes the capacity to resume or reallocate compute resources dedicated to the virtual desktop. Another implementation is where the virtual desktop is provisioned by the infrastructure system and is initially paused after being provisioned by the infrastructure system. Another implementation is where the virtual desktop is configurable to be re-connected unless a pause state is determined by the compute resource optimization service. Another implementation is where if the virtual desktop is in a pause state, feedback is provided to the user of the remote device to indicate a short delay before the virtual machine becomes available. Another implementation is where the compute resources include at least one of processing or memory provided by the infrastructure system.

Another disclosed example is a virtual remote desktop system providing remote devices access to virtual desktops. The virtual desktops consume compute resources. The system includes a compute resource optimization service communicating with a client on a remote device. The system includes a virtual desktop having an agent in communication with the resource optimization service. a virtual infrastructure system is in communication with the compute resource optimization service. The compute resource optimization service optimizes allocation of the compute resources to the virtual desktop from the virtual infrastructure system by setting the virtual desktop in a paused state allowing conservation of the compute resources and a resume state when a user uses the virtual desktop.

Another disclosed example is a method for optimizing processing and/or memory resources for a virtual desktop. User access to a virtual desktop is provided on a remote device. The virtual desktop has a client consuming compute resources on a virtual infrastructure system. A compute resource optimization service communicates with the client on the remote device. Allocation of the compute resources to the virtual desktop from the virtual infrastructure system is optimized via the compute resource optimization service by setting the virtual desktop in one of a plurality of states.

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the present invention, when taken in connection with the accompanying drawings and the appended claims.

### BRIEF DESCRIPTION OF THE DRAWINGS

The disclosure will be better understood from the following description of exemplary embodiments together with reference to the accompanying drawings, in which:

FIG. 1 is a high-level block diagram illustrating an example cloud desktop fabric allowing access to virtual desktops globally;

FIG. 2 is a block diagram of a regional data center and desktop service control plane of the example cloud desktop fabric in FIG. 1;

FIG. 3 is an example diagram showing functions of a virtual machine that may be accessed via a remote device connecting to the cloud desktop fabric in FIG. 1;

FIG. 4A is a graph of compute resources consumed by an example remote user of the system in FIG. 2;

FIG. 4B is a graph of the periods in time for the user in FIG. 4A showing periods where there is no use;

FIG. 4C is a graph of the periods in time for the user where the example compute resource optimization system pauses the virtual machine to conserve compute resources;

FIG. 5 is a block diagram of the architecture of the example compute resource optimization service operated by the desktop service control plane;

FIG. 6 is a state diagram of the states of the virtual desktop during optimization managed by the compute resource optimization service;

FIG. 7 is a process flow of provisioning a new virtual desktop performed by the example compute resource optimization service architecture in FIG. 5;

FIG. 8 is a process flow of connection to a paused virtual desktop performed by the example compute resource optimization service architecture in FIG. 5;

FIG. 9 is a process flow of disconnecting and pausing a virtual desktop performed by the example compute resource optimization service architecture in FIG. 5;

FIG. 10 is a process flow of automatic reconnection performed by the example compute resource optimization service architecture in FIG. 5;

FIG. 11 is a screen image of an example interactive user interface for configuring pause/resume policies of the compute resource optimization service architecture in FIG. 5; and

FIGS. 12 and 13 illustrate exemplary systems in accordance with various examples of the present disclosure.

The present disclosure is susceptible to various modifications and alternative forms. Some representative embodiments have been shown by way of example in the drawings and will be described in detail herein. It should be understood, however, that the invention is not intended to be limited to the particular forms disclosed. Rather, the disclosure is to cover all modifications, equivalents, and alternatives falling within the spirit and scope of the invention as defined by the appended claims.

### DETAILED DESCRIPTION OF THE ILLUSTRATED EMBODIMENTS

The present inventions can be embodied in many different forms. Representative embodiments are shown in the drawings, and will herein be described in detail. The present disclosure is an example or illustration of the principles of the present disclosure, and is not intended to limit the broad aspects of the disclosure to the embodiments illustrated. To that extent, elements and limitations that are disclosed, for example, in the Abstract, Summary, and Detailed Description sections, but not explicitly set forth in the claims, should not be incorporated into the claims, singly or collectively, by implication, inference, or otherwise. For purposes of the present detailed description, unless specifically disclaimed, the singular includes the plural and vice versa; and the word “including” means “including without limitation.” Moreover, words of approximation, such as “about,” “almost,” “substantially,” “approximately,” and the like, can be used herein to mean “at,” “near,” or “nearly at,” or “within 3-5% of,” or “within acceptable manufacturing tolerances,” or any logical combination thereof, for example.

The following are definitions of terms used in this disclosure that relate in general to the virtual desktop system.

An agent is software that performs certain operations and monitoring tasks that has direct access to, or runs on, some virtual computing resource and may maintain a duplex communication channel with a desktop service control plane.

An API is a set of specific, controlled, well-defined functional entry points to get, create, update, and delete resources and otherwise change the state of a remote system.

A cloud API is, in this context, an API specific to an Infrastructure as a Service (IaaS) provider.

A connection broker is desktop service resource sometimes used to dynamically connect desktop clients with desktops.

A datacenter is a collection of computing resources, such as servers, in one physical location.

A virtual desktop is a computer's interactive desktop, or a single interactive application provided without access to the full desktop, or other experience provided by remote desktop virtualization via a desktop service.

A client, or desktop client (sometimes called a VDI client) is a software application that provides display and input access to a desktop as part of a desktop service. It may be installed on a standard desktop or mobile operating system, or be pre-installed on dedicated hardware devices, or downloaded dynamically via a web browser application, or deployed in some other way. Like an agent, it may also perform certain operations and monitoring tasks and may maintain a duplex communication channel with a desktop service control plane.

A cloud desktop fabric is a scalable virtual desktop interface system that orchestrates multiple regional fabric regions to allow a user anywhere in different regions to access a virtual desktop interface.

A desktop service resource refers to some virtualized hardware, networking service, or virtual machine, other than the desktops themselves, that exists to support a desktop service.

A desktop service is remote desktop virtualization hosted on a public or private cloud, provided as a turnkey managed service.

A desktop service control plane is an application that implements and manages a desktop service.

A desktop user is a person who uses a desktop.

An enterprise connector is a desktop service resource used to integrate the network of a desktop service with the network services, including but not limited to directory services that support authentication and authorization.

A gateway, sometimes referred to as a protocol gateway, is a type of desktop service resource running a service that manages secure access to a desktop supporting protocols including a remote display protocol (RDP). In this disclosure, gateways are accessed as a gateway cluster unless explicitly noted otherwise.

A gateway cluster is a set of gateways managed together for load balancing purposes and high availability purposes.

Infrastructure as a service (IaaS) is a set of virtualized computing resources available from a public cloud provider.

An infrastructure template is a collection of desktop service resources and/or definitions that provide a blueprint for replicating a regional cloud datacenter.

A multi-tenant desktop service control plane is a single desktop service control plane implementation that is used by multiple customers in such a way that no single customer is aware of or is impacted by activities of the others.

A non-persistent desktop user is a desktop user that is allocated a new desktop for each login session.

A persistent desktop user is a desktop user that is allocated a specific desktop for exclusive use over multiple connection sessions.

Pool desktops are a set of desktops managed by the desktop service control plane as a unit.

A regional cloud datacenter is a datacenter providing virtualized computing resources to implement a desktop service for efficient access within a single geography or availability zone.

Remote desktop virtualization is software technology that separates the desktop environment and associated application software from the physical client device that is used to access it in a client/server environment.

A virtualized computing resource is a virtual machine that is created by an Infrastructure as a Service (IaaS) provider.

A virtual machine is an emulation of a physical computer that can be accessed over a network.

A virtual network is hardware and software network resources combined into a single, software-based administrative entity, made available by an Infrastructure as a Service (IaaS) provider.

Virtual storage is storage resources provided as part of Infrastructure as a Service.

The present disclosure is directed toward a method and system that optimizes virtual hardware resource consumption, while meeting user experience requirements of application scenarios. The system optimizes utilization of hardware resources not only at the level of each virtual desktop, but at the level of an entire pool of virtual desktops. A combination of a policy-driven configuration and a run-time desktop state management system accomplishes the optimization.

The goal of the example system is to pause the more common, normal state of a virtual desktop at periods of time determined by a policy. The pause incurs minimized costs and resources because the associated compute resources to the virtual desktop are deallocated. Only when the virtual desktop is being used, which is generally a minority of the time, is it resumed. Awareness of the pause/resume operations is minimized, with the goal that such operations are completely transparent to desktop users, or at worst, cause a small and acceptable delay.

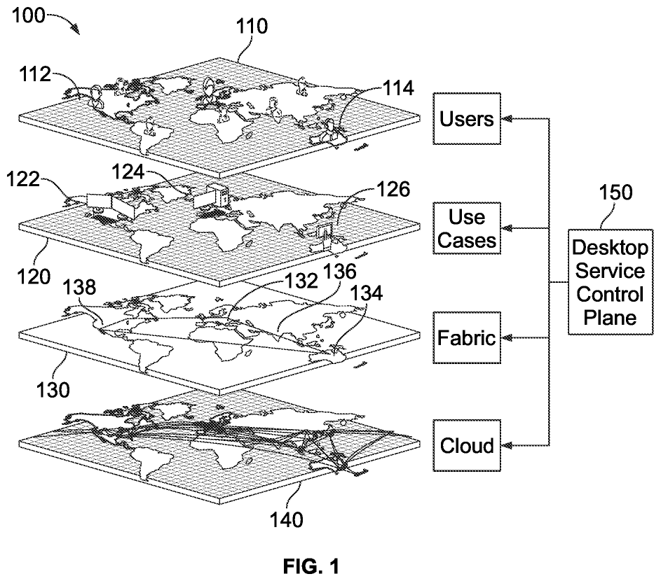

FIG. 1 shows a high level block diagram of a cloud desktop service system 100. The cloud desktop service system 100 may also be referenced as a global desktop system because it provides virtual desktops for users globally. The cloud desktop service system 100 includes four layers, a users layer 110, a use cases layer 120, a fabric layer 130, and a cloud layer 140.

The users layer 110 represents desktop users having the same computing needs, that may be located anywhere in the world. In this example, the users layer 110 includes users 112 and 114, who are in geographically remote locations and access desktops via computing devices.

The use cases layer 120 represents common logical global pools of virtual desktops available to serve the users, whereby each global pool is based on a common desktop template. There can be multiple global pools based on which groups users belong to and their job requirements. In this example, the pool for the users 112 and 114 may be one of a developer desktop pool 122, an engineering workstation pool 124, or a call center application pool 126. Pools such as the developer desktop pool 122 or the engineering workstation pool 124 allow users in the pool a virtual desktop that allows access to graphic processing unit (GPU) based applications. Other example applications may include those applications used for the business of the enterprise, for example, ERP (enterprise resource planning) applications or CRM (customer relationship management) applications. These applications allow users to control the inventory of the business, sales, workflow, shipping, payment, product planning, cost analysis, interactions with customers, and so on. Applications associated with an enterprise may include productivity applications, for example, word processing applications, search applications, document viewers, and collaboration applications. Applications associated with an enterprise may also include applications that allow communication between people, for example, email, messaging, web meetings, and so on.

The fabric layer 130 includes definitions and configurations for infrastructure and desktop service resources, including gateways, desktop templates, and others. The resources are maintained as fabric regions such as a master fabric region 132, and expansion regional fabric regions 134, 136, and 138. As will be explained below, the fabric regions such as the regional fabric regions 134, 136, and 138 can be added or removed as needed. The master fabric region is the configuration of record.

The cloud layer 140 implements the resources defined by the use case layer 120 and fabric layer 130, including virtual desktops, infrastructure, and other virtual resources, all of which are virtual machines or other virtual resources hosted in a public cloud.

The layers 110, 120, 130, and 140 are created and orchestrated by a desktop service control plane 150 that can touch all the layers. The desktop service control plane 150 is a key component to orchestrate a cloud desktop service system such as the cloud desktop service system 100 in FIG. 1. The desktop service control plane 150 can manage the entire lifecycle of a desktop service implementation, from creating and managing the required desktops, to monitoring and analyzing the stream of operational data collected, enforcing security policies, and optimizing the experience for IT administrators and desktop users. For example, the desktop service control plane 150 may register a set of a virtual networks, virtual storage resources, and more. Within a virtual network, the control plane 150 may further register and coordinate the use of gateways, enterprise connectors, desktop templates, connection brokers, and more.

The two desktop users 112 and 114 in different parts of the world who are each able to access an example high-performance desktop service from the cloud desktop service system 100. As will be explained below, the cloud desktop service system 100 eliminates the need to divide users with similar requirements into user groups specific to a region. Rather, all users having similar needs throughout the world are considered as a single worker pool. Users, such as users 112 and 114, each may use a client device to access the desktop service. Client devices may be any device having computing and network functionality, such as a laptop computer, desktop computer, smartphone, or tablet. Client devices execute a desktop client to access remote applications such as the desktop. The client application authenticates user access to the applications. A client device can be a conventional computer system executing, for example, a Microsoft™ Windows™-compatible operating system (OS), Apple™ OS X, and/or a Linux distribution. A client device can also be a client device having computer functionality, such as a personal digital assistant (PDA), mobile telephone, tablet, video game system, etc.

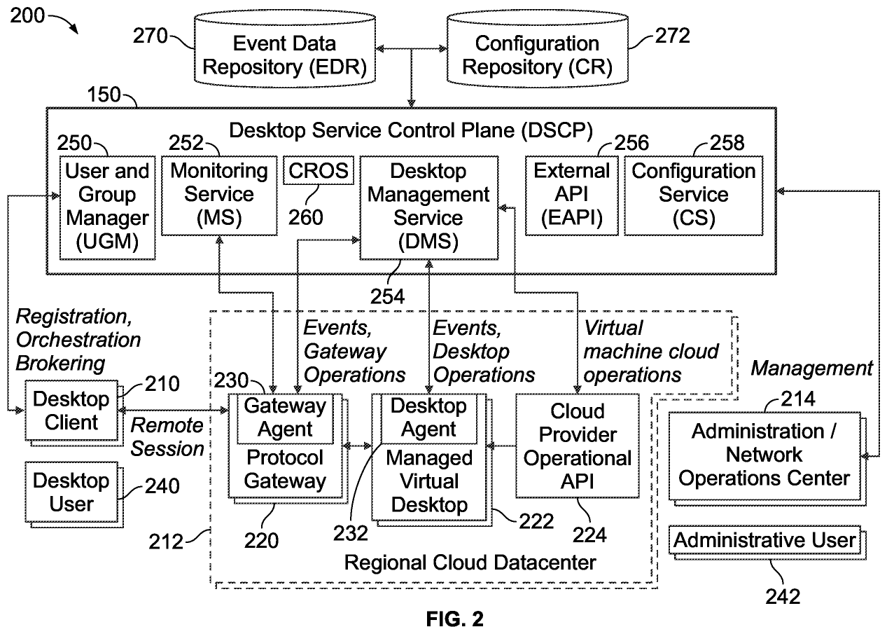

FIG. 2 is a block diagram of some examples of components of the global desktop service system 100, including an example set of desktop clients 210, a regional cloud datacenter 212, and an administration center 214, that interact with and can be orchestrated by the desktop service control plane 150. The desktop client 210 communicates with the desktop service control plane 150 in order to be registered with the fabric, assigned a desktop, remotely configured, and for other purposes. There may be multiple regional cloud datacenters similar to the regional cloud datacenter 212, but only one datacenter is shown in detail for simplicity of explanation. The regional cloud datacenter 212 may include a set of protocol gateways 220, a set of managed virtual desktops 222, and a cloud provider operational API 224. These components all communicate with the desktop service control plane 150. Such datacenters include servers that host the various applications. The datacenter typically comprises IT infrastructure that is managed by IT personnel. The IT infrastructure may include servers, network infrastructure, software, and so on. If there is an issue related to an application reported by a user, the IT personnel can check the health of the infrastructure used by the application. A datacenter may include a firewall to control access to the applications hosted by the datacenter. The firewall enables computing devices behind the firewall to access the applications hosted by the datacenter, but prevents computing devices outside the firewall from directly accessing the applications. The firewall may allow devices outside the firewall to access the applications within the firewall using a virtual private network (VPN).

The protocol gateway 220 may be present to provide secure public or internal access to the managed virtual desktops. A gateway agent 230 is software that is deployed on that gateway host by the desktop service control plane 150, and serves to monitor the activity on the gateway 220, and enable the desktop service control plane 150 to assist in configuration and operations management of the gateway.

The example desktop client 210 is software and device hardware available in the local environment of a desktop user 240 to remotely access a managed virtual desktop using a remote desktop protocol. The desktop client 210 communicates with the desktop service control plane 150/

The managed virtual desktop 222 is itself provisioned and maintained by the desktop service control plane 150. A desktop agent such as desktop agent 232 is software that is deployed on that managed virtual desktop by the desktop service control plane 150, and serves to monitor the activity on the managed virtual desktop, and enable the desktop service control plane 150 to assist in configuration and operations management of the virtual desktop.

The cloud provider operational application programming interface (API) 224 presents services provided by the cloud provider that also participate in the management of the virtual machine. This can be utilized by a desktop service control plane 150 to perform operations like provisioning or de-provisioning the virtual machine.

Administrative users 242 can interact with network operations center software at the administration center 214 that allows management and administration of the desktop service control plane 150.

Other components and services may interact with the desktop service control plane 150 but are omitted from FIG. 2 for simplicity. These components and services may include enterprise connectors, network monitoring services, customer relationship management (CRM) systems, and many others.

The desktop service control plane 150 itself can perform many internal centralized functions also not depicted in in FIG. 2, including pool management, user and group management, cloud service adapters, virtual desktop templates, data analysis, high-availability management, mapping users to the optimal regional data center, security policy management, monitoring, compliance, reporting, and others.

The control plane 150 includes a user and group manager 250, a monitoring service 252, a desktop management service (DMS) 254, an external API (EAPI) 256, a configuration service (CS) 258, and a compute resource optimization service (CROS) 260. The control plane 150 may access an event data repository 270 and a configuration repository 272 for storing and reference to relevant operational data. Although only one regional datacenter 212 is shown in detail, it is to be understood that the control plane 150 may facilitate numerous regional datacenters.

The monitoring service 252 makes both routine and error events available to administrators and can analyze operational performance and reliability. The desktop management service 254 interacts with the one or more managed virtual machines (MVMs) 222 in the regional cloud datacenter 212.

The administration center 214 works directly with the desktop service control plane 150 as its primary human interface. The administration center 214 allows the administrative user 242 to configure the functions of the control plane 150 through the configuration service 258. The configuration service 258 supports editing and persistence of definitions about the desktop service, including subscription information and policies. In this example, the policies include optimization policies that pause virtual desktops to conserve compute resources.

The global desktop service system 100 includes a large number of desktop service resources, including many virtual machines, virtual networks, and other services. Managing a global desktop service system, and ensuring that it is running in a performant, secure, and resilient fashion, can become very complex because of the large number of dependencies between desktop users and desktop service resources, and among desktop service resources. As will be explained the compute resource optimization service (CROS) 260 optimizes usage of compute resources of the system 100 supporting the virtual desktops.

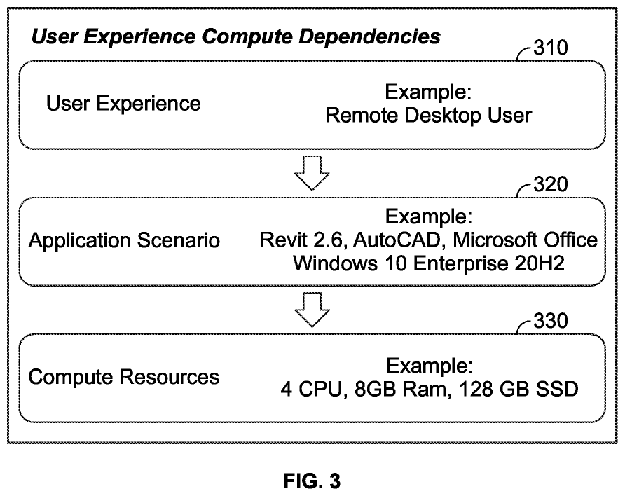

FIG. 3 is a diagram that shows the dependencies of an acceptable user experience such as that of the user 240 in FIG. 2. The user 240 may be remote desktop user that executes the desktop client 210 on a local computer and expects a certain quality of user experience 310. This in turn depends on the performance of a set of one or more application(s) installed on the same desktop to be available for certain periods of time to solve a specific set of business use cases as explained above. The applications available may be an application scenario 320. For example, a user may be designing a specification for large engineering project. The set of installed applications may include computer aided design and rendering tools, project inventory management tools, and video processing facilities. Furthermore, these tools may all need to be run concurrently and interact with each other. Additionally, the desktop operating system environment can be considered another part of the application scenario. As such, the desktop operating system adds another set of processor and memory requirements.

The principles described herein relate to application scenarios 320 in which every user is allocated a dedicated virtual desktop that can have its own file system state and customized experiences (such as keyboard shortcuts, window arrangements, and so on). Every application scenario 320 has implicit, or possibly explicit, performance requirements. For example, in order to produce a rendering of a certain blueprint, it may be considered a failed user experience if it takes longer than a certain number of minutes. In other cases, such as a routine menu selection, the performance requirement is that it take less than 1 second.

The speed of a particular operation may be dependent on many factors, including the performance of disk storage, network speed, or network bandwidth. These may be collectively referenced as required compute resources 330. The compute resources are related to the performance implication of the virtual hardware profile, including the number and/or rating of processors such as CPUs or GPUs, and the amount of RAM memory available. As part of the application scenario 320, there are peak performance requirements that cover the most demanding operations needed by a user. To handle this, as an example, some application scenarios may require that the CPU is generally not utilized at more than 75%, and at least 10 GB of free RAM available to handle peak operational requirements. If adding more processor capacity speeds up an operation, that operation is considered to be CPU-bound. If adding more RAM speeds the operation up, it is considered to be memory-bound.

An application scenario and its operating system environment are run on certain desktop hardware components, which may be physically co-located with the user, or may be “virtual machines” that are accessed remotely and/or indirectly by a service provider, in which the physical hardware involved may be a different solution that emulates the physical machine attributes expected by the user.

Hardware resources are provisioned by providers of both physical and virtual hardware. They are available in various permutations known as hardware classes, that each have their own total capacity and associated costs. For example, for one hardware class, there may be an array of CPUs, each of which may only support a certain number of operations per seconds. RAM can only represent a finite amount of volatile data. A disk can only store a finite amount of persistent data. Therefore, although hardware components can generally be shared between application processes, they may be considered to be consumable resources for any given moment of time.

Virtual machines supported by the system 100 in FIGS. 1-2 may be employed in many different industrial uses, such as web services that respond to requests constantly. Application scenarios for virtual desktops, more specifically, are designed for individual users interacting with desktop software, and typically do not follow a pattern of constant requests. Desktop application scenarios may utilize compute resources sporadically, may rarely require peak operational performance, and are often completely idle. For example, the desktop user 240 in FIG. 2 begins interactively using the desktop for some duration of time during a work day. Thus, for some hours of the day, the desktop is generally unused. The patterns of use can vary greatly by application scenario, and some uses may fall outside of any pattern.

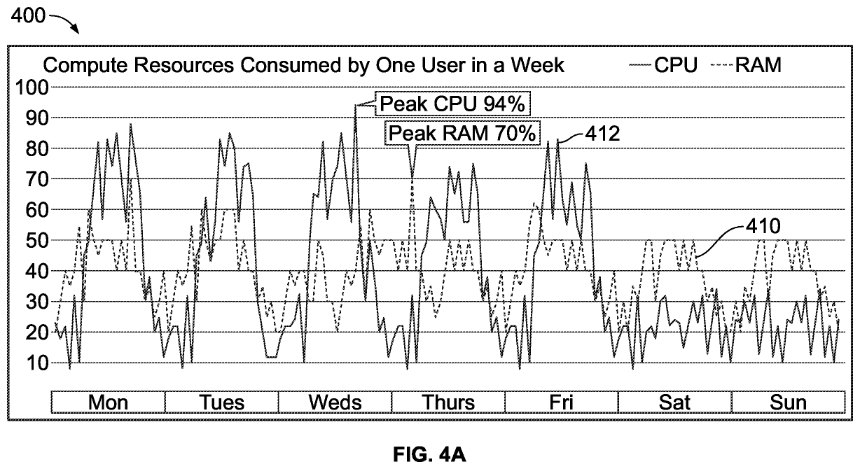

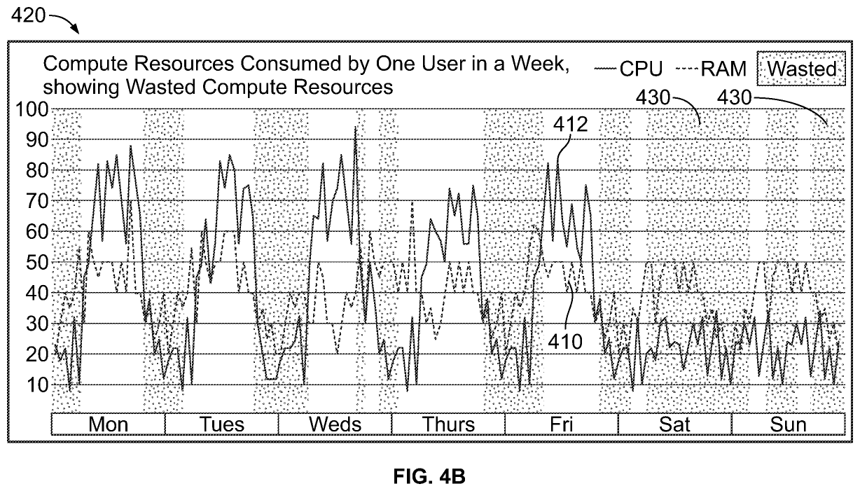

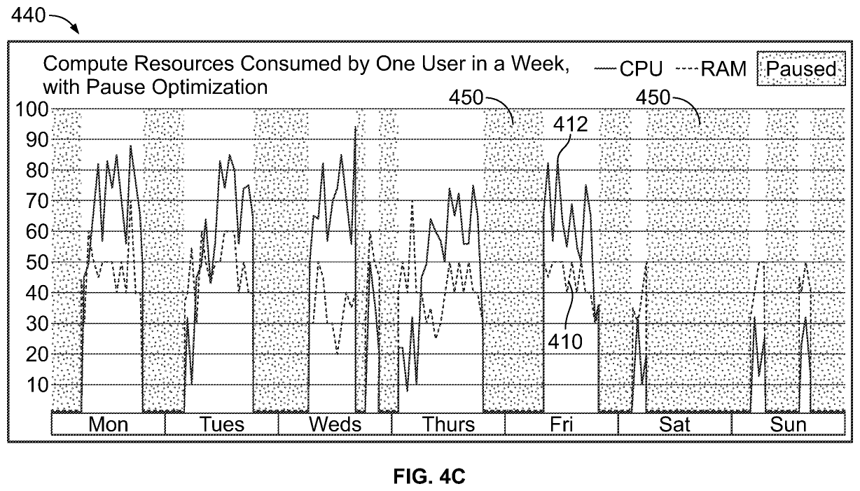

As an application scenario is used, the consumption of hardware compute resources varies over time for each desktop user. Some operations consume more CPU or GPU resources; others consume more memory resources such as RAM memory. Some are long operations, and some very short. FIG. 4A is a graph 400 of compute resources for a specific hardware class consumed by an example user during a week. The graph shows a trace of processing (CPU) resources 410 and a trace of memory (RAM) resources 412 during times of each day of the week. As shown by the traces 410 and 412, peak usages of processing resources and memory resources occur during the middle of typical working days, Monday through Friday. Low use of such resources occurs at night time and early morning as well as weekend days such as Saturday and Sunday.

FIG. 4B is a graph 420 that shows the resource use in FIG. 4A with wasted periods of compute resource consumption shown as blocks 430, when the user is not even connected to the virtual desktop. Because of the lack of resource optimization, known virtual desktop service systems face similar costs to physical hardware provisioning, without an optimization solution such as the compute resource optimization service 260. A system providing virtual machines such as the system 200 in FIG. 2 have several capabilities to dynamically manage compute resources for a particular virtual machine through the compute resource optimization service (CROS) 260. One capability is to pause a virtual machine, meaning that the service can dynamically deallocate compute resources at any time. A compute resource that is paused has a different, and typically much lower, cost structure than a running compute resource. For example, the cloud provider may charge significantly less for paused compute resources, in some cases no more than the cost of the disk storage to keep the last known state of the virtual machine before it was paused. Another capability is to quickly resume, or reallocate compute resources that were previously paused, restoring the exact memory and processor state of the virtual machine. Because of these capabilities, the cost of compute resources no longer needs to be constant.

FIG. 4C shows a graph 440 derived from the compute resource graph 400 of FIG. 4A to show periods where the compute resources are paused for CPU and RAM consumption over the course of one week for one virtual desktop of a particular hardware class. The periods where the compute resources are paused are illustrated by blocks 450 in FIG. 4C based on the implementation of the compute resource optimization service 260. While the virtual desktop is not actively used (in this example, this is typically evenings and weekends) it is paused by the compute resource optimization service 260. The previously wasted compute resources in FIG. 4B are now saved and may be reallocated to other tasks.

In this example, virtual desktops are initially paused after they are provisioned and made ready by the desktop infrastructure system 200 in FIG. 2. At the time a user initiates a connection to a paused desktop through the desktop client 210, the desktop is automatically resumed for the user. Once a connected session on the virtual desktop for a user has become idle (no interaction detected for some period of time), the system 200 may decide to pause the desktop based on configured policies. Once a user has explicitly disconnected from a desktop, the system 200 decides when to pause the desktop based on built-in or configured policies managed by the compute resource optimization service 260. When an automatic reconnection occurs, the system 200 will decide whether a resume is required based on configured policies and the current state of the virtual desktop.

For example, in a scenario without the pause and resume capability of the example system, a virtual desktop is running all the time, that is, for 24 hours a day or 168 hours per week. If the cost of a fully running machine is $10 per hour, the cost per week per user is $1,680. With the pause and resume capability, a virtual desktop might be resumed to cover a 9 AM to 5 PM regular work shift of 40 hours out of the full 168 hours of the week, so the virtual desktop is paused for 128 hours per week. The cost of a paused machine (for example $1 per hour) is much less than the cost of a resumed machine. In this example, the compute resource cost is (40×$10)=$400 for the resumed time, plus (128×$1), or $128, for the paused time, for a total of $528, or approximately =31% of the full compute resource cost without pause/resume. Depending on the amount of actual use, and actual costs, the savings provided by the example pause and resume capability will vary.

The use of the pause capability during periods of low usage allows several advantages and improvements. First, the pause capability allows optimal sharing of compute resources across different users in different time zones using the system 200. The system 200 allows lower cost of compute resources leading to higher margins. Further, providers of the system 200 incur costs dynamically, which enables more granular billing, such as hourly billing, instead of flat-rate plans, giving more flexibility to consumers.

Policies about compute resource optimization may be applied in aggregate to multiple virtual desktops based on various groupings and/or rules for the system 100 in FIG. 1. For example, a policy may be applied to a pool of virtual desktops managed by the system 200 in FIG. 2, affecting every virtual desktop in the pool. Alternatively, a policy may be applied to multiple virtual desktops based on a rule about an end user's time-zone, an end user groupings or other attributes.

The compute resource optimization service 260 can be implemented to support options explicitly defined and configured as part of the system 200 in FIG. 2, or may work with pre-existing configurability that is already present in components that are utilized by the system 200. An example of an explicitly provided policy would be a rule defined within the compute resource optimization service 260 that causes the compute resource optimization service 260 to disconnect an idle user as defined by the policy. A similar rule may be natively enforced by the operating system and remote display protocol itself, and this external configuration may work just as well with the compute resource optimization service 260.

Another example of a configurable policy is the ability to specify a delay period that follows a disconnection before a pause automatically occurs. This is useful in cases where a user may often wish to reconnect to the virtual desktop quickly after a short break. Another example of a configurable policy is the ability to specify a period of “normal work hours,” during which no automatic pause can take effect. This policy is useful to optimize user experience by allowing for instant reconnection during the periods when the user is likely to be working, and minimizing delays in reconnection.

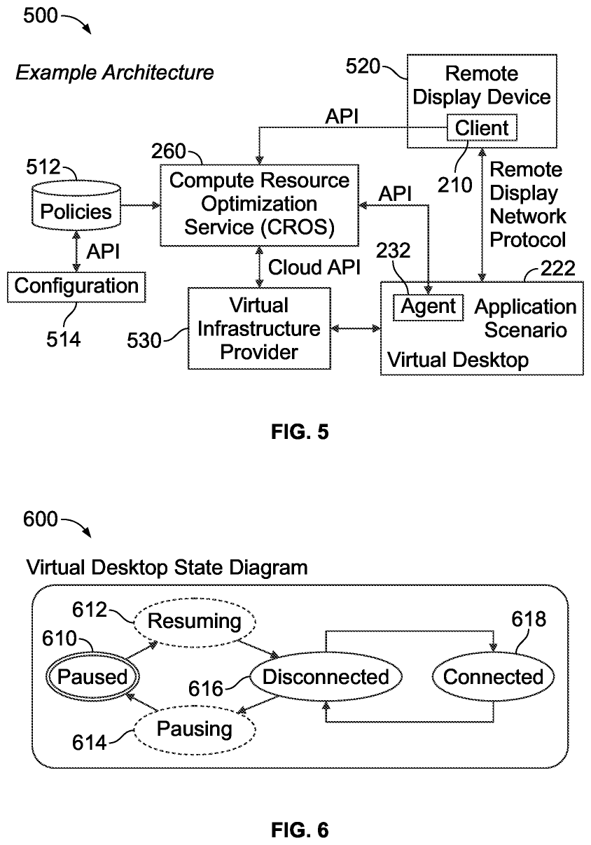

FIG. 5 is a block diagram of an example compute resource optimization service architecture 500 of the compute resource optimization service 260 for implementing a pause to conserve virtual resources. The architecture 500 is centered around the compute resource optimization service 260. The compute resource optimization service 260 accesses different policies 512. The policies 512 may be selected by a configuration interface 514 accessible by a system administrator.

An end user uses a remote display device such as a device 520 running the client 210 to establish a remote display protocol connection to a virtual desktop such as the virtual desktop 222. The end user uses a particular application scenario on the virtual desktop 222. The virtual desktop 222 includes the agent 232 that monitors the activity on the managed virtual desktop and assists in configuration and operations management. For example, the agent 232 sends event information when remote desktop protocol connections are established or changed, and can report performance metrics such as CPU and memory utilization. Furthermore, the agent 232 may implement commands such as shutting down or rebooting the virtual machine. The agent 232 interfaces with the virtual desktop infrastructure system 200 that is run by a cloud virtual infrastructure provider 530 in this example. The client 210 is installed software on that remote display device 520 that manages this connection, and communicates with the compute resource optimization service 260 about connection events.

In this example, the compute resource optimization service 260 interacts with the cloud virtual infrastructure service provider 530 to handle pause/resume requests for the virtual desktop 222. The policies 512 are created and persistently maintained by the administrators of system 200 for the compute resource optimization service 260 in order to control its behavior as related to pause/resume optimizations of resources for the virtual desktops. This can be done with the interactive user interface 514 providing options and default values in a standard way. There are many possible implementations of this capability.

In one example, the compute resource optimization service 260 tracks at least five distinct states of a virtual desktop. Of course, there will likely be at least one more state defined for error handling purposes such as a state representing a failed virtual desktop. FIG. 6 is a virtual desktop state diagram of the compute resource optimization service 260 that includes a paused state 610, a pausing state 614, a resuming state 616, a disconnected state 618, and a connected state 620. In this example, the paused state 610 is the default or normal state of a virtual desktop when it is not being actively used. The resuming state 616 is a transitory state that exists after the resume operation has been initiated but before it is completed. The disconnected state 618 is a state that represents that the virtual desktop that has been fully resumed, and is ready for connection and use. The connected state 620 is a state that represents that the client has a remote display protocol session with the virtual desktop, and application scenarios are able to be used interactively. The connected state 620 implies that the virtual desktop is running normally. The pausing state 614 is a transitory state that exists after the pause operation has been initiated for a disconnected client, but before pause has completed.

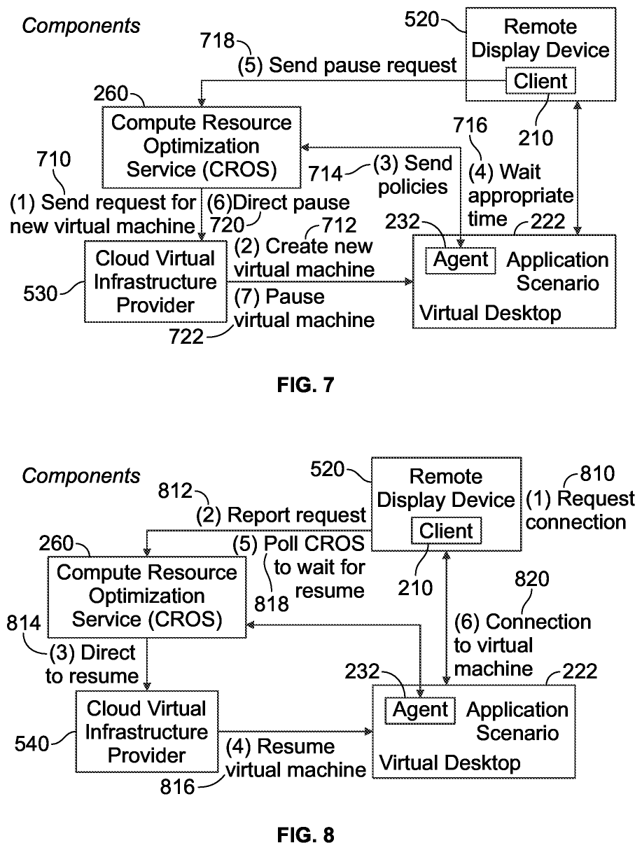

FIG. 7 shows the process of provisioning a virtual desktop performed by the architecture 500. The provisioning process begins by the compute resource optimization service 260 sending a request for a new virtual machine to Cloud virtual infrastructure provider 530 (710). The virtual infrastructure provider 530 creates the new virtual machine (712). The virtual infrastructure provider 530 creates the new virtual machine according to a desktop template as specified in the configuration of the desktop service control plane 200. The creation of the new virtual machine includes allocating appropriate compute, disk, network, and other infrastructure resources. The compute resource optimization service 260 sends policies to the agent 232 (714), including an Inactivity Timeout setting. The agent 232 waits an appropriate time according to the Inactivity Timeout setting in the policy (716). If there is no activity within the specified timeout, the agent 232 sends a pause request to the compute resource optimization service 260 (718). The compute resource optimization service 260 then directs the cloud virtual infrastructure provider 530 to pause the virtual desktop (720). The cloud provider 530 then pauses the virtual desktop.

FIG. 8 shows the process of connection to a paused virtual desktop performed by the architecture 500. The normal state of a virtual desktop is to be paused. Whenever an end user deliberately attempts to connect to the virtual desktop 222, the client 210 triggers a resume by requesting a resume from the compute resource optimization service 260. The compute resource optimization service 260 waits until the virtual desktop 222 is resumed (but disconnected) and then connects to the virtual desktop 222 as it normally would for any virtual desktop it has access to.

It is also possible that the compute resource optimization service 260 can be configured to bring the virtual desktop 222 to a pristine status, in which all persisted files and user configuration settings are reset to the same state as a freshly-provisioned virtual desktop. This may be done every time the virtual desktop is resumed. This option may be employed in environments where there are legal requirements preventing leftover files or stored configurations that were created by a user in an earlier session to be retained. In effect, whenever a user is given access to a resumed virtual desktop, it is equivalent to a freshly-provisioned virtual desktop.

As shown in FIG. 8, a user of the remote display device 520 first explicitly requests connection (810). This request is received by the client 210 and reported to the compute resource optimization service 260 (812). The compute resource optimization service 260 directs the Cloud virtual infrastructure provider 530 to resume (814). The Cloud virtual infrastructure provider 530 then resumes the virtual desktop 222 (516). This does not require provisioning any new resources, but does require the cloud virtual infrastructure provider 530 to resume the existing resources. The client 210 polls the compute resource optimization service 260 to wait for the resume (818). The client 210 then connects the virtual desktop 222 (820). This allows the user to access the virtual desktop 222 for connected usage.

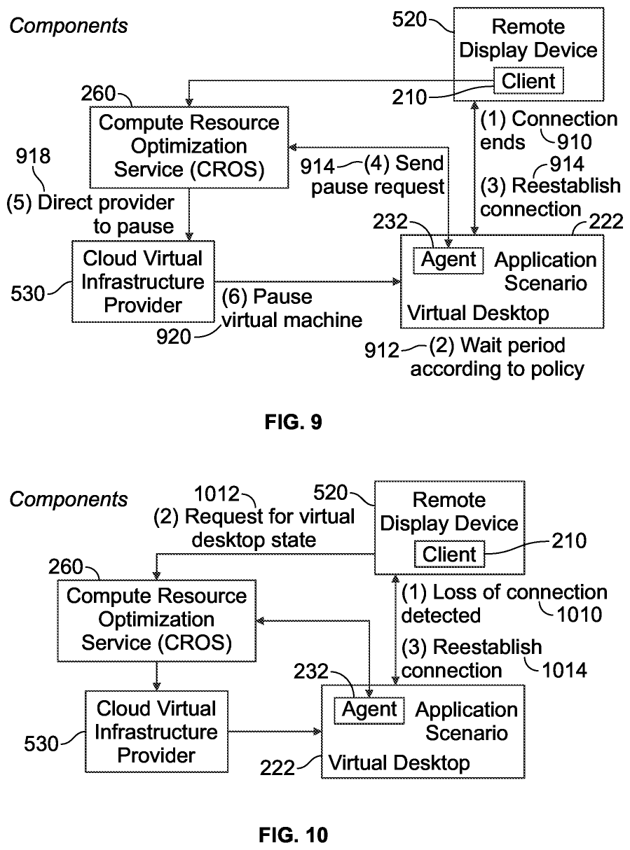

FIG. 9 shows the process of disconnecting and pausing a virtual desktop such as the virtual desktop 222 performed by the architecture 500. Disconnection and pause occurs once the user is no longer connected to the virtual desktop 222. The agent 232 handles the triggering of the pause operation. Based on the policies that were previously sent to the agent 232, the agent 232 may wait some period of time, as specified by the inactivity timeout, before triggering the pause. The agent 232 tracks the waiting time as a timeout counter. During this period of time, the client 210 may reestablish a connection to the virtual desktop 222 and the timeout counter is reset. Assuming any configured timeout interval has passed, the agent 232 sends the pause request to compute resource optimization service 260. The compute resource optimization service 260 in turn delegates the request to the virtual service provider 530. At this point, the virtual desktop 222 (including the agent 232) is paused and is unavailable. Alternatively, the decision to pause may be made by the compute resource optimization service 260.

The process is initiated by the connection of the remote display device 520 to the agent 232 ending by explicit logout, explicit disconnect or a protocol idle connection timeout (910). For example, the user may have simply let the connection go idle without any activity, or may have shut down the client program. The agent 232 waits an appropriate time (912) as set out by the policy selected by the compute resource optimization service 260. During the time, a reconnection may occur based on a request made by the client 210 (914) such as when the user reconnects in some fashion. This can happen by the user explicitly requesting a connection, or by resuming the client program.

If the period of time for pause expires, the agent 232 sends a pause request to the compute resource optimization service 260 (916). The compute resource optimization service 260 directs the Cloud virtual infrastructure provider 530 to pause (918). The Cloud virtual infrastructure provider 530 pauses the virtual desktop 222 (920).

FIG. 10 shows the process of automatic reconnection performed by the architecture 500. Remote display devices that host the client 210 such as the device 520 have the ability to hibernate (or sleep) based on lack of activity or other conditions such as closing the lid of a laptop, or deactivating a mobile device. When the client 210 is activated again such as by waking up the remote display device 520, the client 210 will detect that it no longer has a connection to a virtual desktop to which it was previously connected. However, the client 210 does not know whether the virtual desktop 222 is in a paused state or is simply disconnected.

Attempting to reconnect to the virtual desktop 222 is not optimal behavior, because the virtual desktop 222 may be paused and there is no reason for it to be resumed. Therefore, the client 210 will ask the compute resource optimization service 260 to send the state of the virtual desktop 222 before taking action. If the virtual desktop 222 is simply in the disconnected state, the client will automatically attempt to reconnect. Otherwise, the client 210 will do nothing until the user explicitly attempts to create a connection, as described above.

A detection of a loss of connection (1010) occurs from the client 210. The loss of connection detection may occur with a network problem or when the client 210 is reactivated after the remote device 520 is awakened. The client 210 asks the compute resource optimization service 260 for the state of the virtual desktop (1012). If the virtual desktop 222 is in a paused state, the client 210 ignores the reactivation, as a connection still exists and a user may access the virtual desktop 222 through the client 210. If the virtual desktop 222 is disconnected, the client 210 performs a simple reconnection (1014).

Failures that affect end users typically occur while attempting to connect to a paused virtual desktop. Information is returned by the compute resource optimization service 260 to the client so it can handle various scenarios. One scenario may be if the virtual desktop was not paused. The client 210 simply connects to the disconnected virtual desktop 222 instantly. Another scenario is if the virtual desktop 222 was paused, the client 210 may give feedback to the user to indicate a short delay while the virtual desktop 222 is resumed. Thus, the client 210 may display an interface to the remote display deice 520 asking the user to wait.

If the virtual desktop 222 fails to resume, but the compute resource optimization service 260 is retrying that operation, the client 210 may display an interface to the user to the effect that the virtual desktop is taking longer than usual to restart, but is attempting to retry. If the virtual desktop 222 fails to resume, and the virtual cloud provider 530 has provided information to the compute resource optimization service 260 that the failure is due to a temporary problem, the client 210 may display an interface to the user that the desktop is not available now, but to try to access it again later.

If the virtual desktop 222 fails to resume, and the virtual cloud provider 530 has provided information to the compute resource optimization service 260 that a reboot of the virtual desktop 222 might solve the problem, the client 210 may display an interface to the user that the virtual desktop 222 requires a reboot. If the virtual desktop 222 fails to resume, and the virtual cloud provider 530 has provided information to the compute resource optimization service 260 that the problem has no known self-correction activity, the client 210 may display an interface to the user that the desktop is not available and to contact their support team.

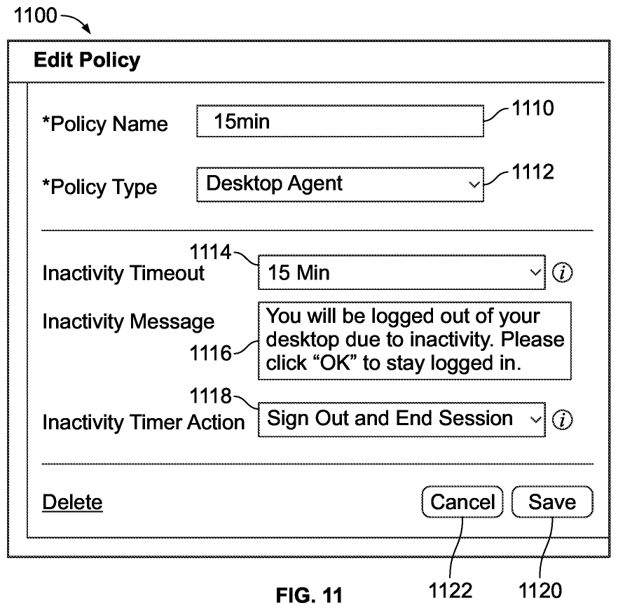

FIG. 11 is a screen image 1100 of an example interactive user interface, such as the interface 514 in FIG. 5 for configuring pause/resume policies of the compute resource optimization service architecture 500. The example screen image 1100 of the interactive user interface shown in FIG. 11 shows a display of editable policy properties for a policy that will affect the behavior of the agent 232 in FIG. 2. In this example, the interface includes a policy name field 1110, a policy type selection field 1112, an inactivity timeout selection field 1114, an inactivity message field 1116, and an inactivity timer action selection field 1118. The example fields 1110, 1112, 1114, 1116, and 1118 allow an administrative user to edit the policy properties. The selected properties may be saved via a save button 1120. Entries in any of the fields 1110, 1112, 1114, 1116, and 1118 may be canceled by selecting a cancel button 1122.

In this example, the administrative user may provide a policy name in the file policy name field 1110 that gives the policy a unique identity. The policy type field 1112 provides a dropdown list of the possible components in the system 100 that the policy is applied. In this example, a selection of “Desktop Agent” causes the policy to be applied to the agent 232 in FIG. 2. The interface 1100 may therefore be used for other policies other than configuring pause and resume policies for desktop agents. The administrative user may select different times for the inactivity timeout selection field 1114. The selected time controls how many minutes will elapse after the end user stops interacting with the virtual desktop before the policy is applied. The administrative user may provide a message via the inactivity message field 1116 that controls what the end user sees on the remote device after the timeout occurs. The administrative user may select an action via the inactivity timer action field 1118. This controls the behavior after timeout, with the default choice to being to sign out and end the session. Another optional action could be to disconnect from the session but leave it running. In the case of pause/resume functionality, sign out also causes the virtual machine to be paused.

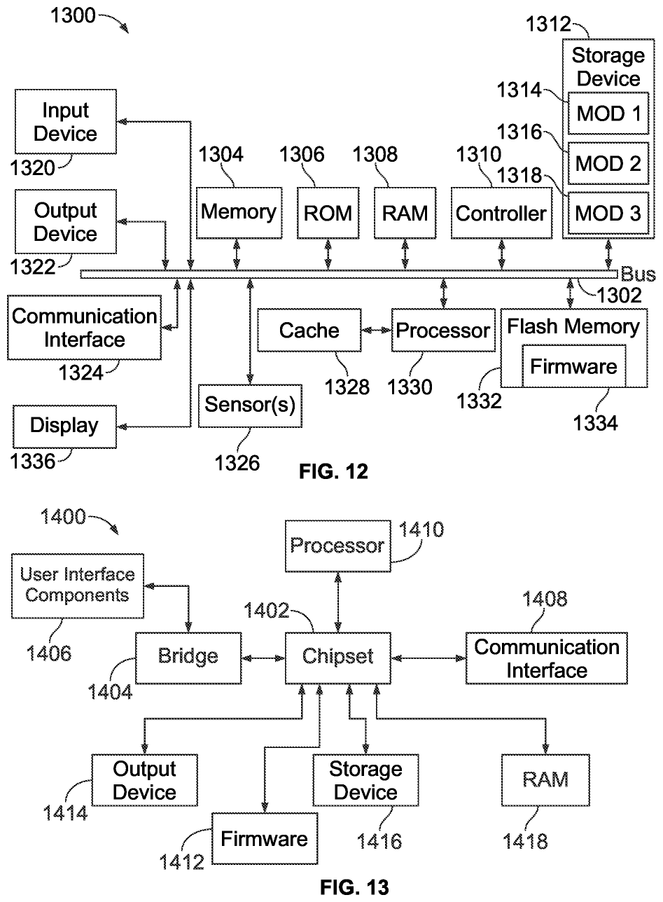

FIGS. 12-13 illustrate an example computing system 1300, in which the components of the computing system are in electrical communication with each other using a bus 1302. The system 1300 includes a processing unit (CPU or processor) 1330 and a system bus 1302 that couple various system components, including the system memory 1304 (e.g., read only memory (ROM) 1306 and random access memory (RAM) 1308), to the processor 1330. The system 1300 can include a cache of high-speed memory connected directly with, in close proximity to, or integrated as part of the processor 1330. The system 1300 can copy data from the memory 1304 and/or the storage device 1312 to the cache 1328 for quick access by the processor 1330. In this way, the cache can provide a performance boost for processor 1330 while waiting for data. These and other modules can control or be configured to control the processor 1330 to perform various actions. Other system memory 1304 may be available for use as well. The memory 1304 can include multiple different types of memory with different performance characteristics. The processor 1330 can include any general purpose processor and a hardware module or software module, such as module 1 1314, module 2 1316, and module 3 1318 embedded in storage device 1312. The hardware module or software module is configured to control the processor 1330, as well as a special-purpose processor where software instructions are incorporated into the actual processor design. The processor 1330 may essentially be a completely self-contained computing system that contains multiple cores or processors, a bus, memory controller, cache, etc. A multi-core processor may be symmetric or asymmetric.

To enable user interaction with the computing device 1300, an input device 1320 is provided as an input mechanism. The input device 1320 can comprise a microphone for speech, a touch-sensitive screen for gesture or graphical input, keyboard, mouse, motion input, and so forth. In some instances, multimodal systems can enable a user to provide multiple types of input to communicate with the system 1300. In this example, an output device 1322 is also provided. The communications interface 1324 can govern and manage the user input and system output.

Storage device 1312 can be a non-volatile memory to store data that is accessible by a computer. The storage device 1312 can be magnetic cassettes, flash memory cards, solid state memory devices, digital versatile disks, cartridges, random access memories (RAMs) 1308, read only memory (ROM) 1306, and hybrids thereof.

The controller 1310 can be a specialized microcontroller or processor on the system 1300, such as a BMC (baseboard management controller). In some cases, the controller 1310 can be part of an Intelligent Platform Management Interface (IPMI). Moreover, in some cases, the controller 1310 can be embedded on a motherboard or main circuit board of the system 1300. The controller 1310 can manage the interface between system management software and platform hardware. The controller 1310 can also communicate with various system devices and components (internal and/or external), such as controllers or peripheral components, as further described below.

The controller 1310 can generate specific responses to notifications, alerts, and/or events, and communicate with remote devices or components (e.g., electronic mail message, network message, etc.) to generate an instruction or command for automatic hardware recovery procedures, etc. An administrator can also remotely communicate with the controller 1310 to initiate or conduct specific hardware recovery procedures or operations, as further described below.

The controller 1310 can also include a system event log controller and/or storage for managing and maintaining events, alerts, and notifications received by the controller 1310. For example, the controller 1310 or a system event log controller can receive alerts or notifications from one or more devices and components, and maintain the alerts or notifications in a system event log storage component.

Flash memory 1332 can be an electronic non-volatile computer storage medium or chip that can be used by the system 1300 for storage and/or data transfer. The flash memory 1332 can be electrically erased and/or reprogrammed. Flash memory 1332 can include EPROM (erasable programmable read-only memory), EEPROM (electrically erasable programmable read-only memory), ROM, NVRAM, or CMOS (complementary metal-oxide semiconductor), for example. The flash memory 1332 can store the firmware 1334 executed by the system 1300 when the system 600 is first powered on, along with a set of configurations specified for the firmware 1334. The flash memory 1332 can also store configurations used by the firmware 1334.

The firmware 1334 can include a Basic Input/Output System or equivalents, such as an EFI (Extensible Firmware Interface) or UEFI (Unified Extensible Firmware Interface). The firmware 1334 can be loaded and executed as a sequence program each time the system 1300 is started. The firmware 1334 can recognize, initialize, and test hardware present in the system 600 based on the set of configurations. The firmware 1334 can perform a self-test, such as a POST (Power-On-Self-Test), on the system 1300. This self-test can test the functionality of various hardware components such as hard disk drives, optical reading devices, cooling devices, memory modules, expansion cards, and the like. The firmware 1334 can address and allocate an area in the memory 1304, ROM 1306, RAM 1308, and/or storage device 1312, to store an operating system (OS). The firmware 1334 can load a boot loader and/or OS, and give control of the system 1300 to the OS.

The firmware 1334 of the system 1300 can include a firmware configuration that defines how the firmware 1334 controls various hardware components in the system 1300. The firmware configuration can determine the order in which the various hardware components in the system 1300 are started. The firmware 1334 can provide an interface, such as an UEFI, that allows a variety of different parameters to be set, which can be different from parameters in a firmware default configuration. For example, a user (e.g., an administrator) can use the firmware 1334 to specify clock and bus speeds, define what peripherals are attached to the system 1300, set monitoring of health (e.g., fan speeds and CPU temperature limits), and/or provide a variety of other parameters that affect overall performance and power usage of the system 1300. While firmware 1334 is illustrated as being stored in the flash memory 1332, one of ordinary skill in the art will readily recognize that the firmware 1334 can be stored in other memory components, such as memory 1304 or ROM 1306.

System 1300 can include one or more sensors 1326. The one or more sensors 1326 can include, for example, one or more temperature sensors, thermal sensors, oxygen sensors, chemical sensors, noise sensors, heat sensors, current sensors, voltage detectors, air flow sensors, flow sensors, infrared thermometers, heat flux sensors, thermometers, pyrometers, etc. The one or more sensors 1326 can communicate with the processor, cache 1328, flash memory 1332, communications interface 1324, memory 1304, ROM 1306, RAM 1308, controller 1310, and storage device 1312, via the bus 1302, for example. The one or more sensors 1326 can also communicate with other components in the system via one or more different means, such as inter-integrated circuit (I2C), general purpose output (GPO), and the like. Different types of sensors (e.g., sensors 1326) on the system 1300 can also report to the controller 1310 on parameters, such as cooling fan speeds, power status, operating system (OS) status, hardware status, and so forth. A display 1336 may be used by the system 1300 to provide graphics related to the applications that are executed by the controller 1310.

FIG. 13 illustrates an example computer system 1400 having a chipset architecture that can be used in executing the described method(s) or operations, and generating and displaying a graphical user interface (GUI). Computer system 1400 can include computer hardware, software, and firmware that can be used to implement the disclosed technology. System 1400 can include a processor 1410, representative of a variety of physically and/or logically distinct resources capable of executing software, firmware, and hardware configured to perform identified computations. Processor 1410 can communicate with a chipset 1402 that can control input to and output from processor 1410. In this example, chipset 1402 outputs information to output device 1414, such as a display, and can read and write information to storage device 1416. The storage device 1416 can include magnetic media, and solid state media, for example. Chipset 1402 can also read data from and write data to RAM 1418. A bridge 1404 for interfacing with a variety of user interface components 1406, can be provided for interfacing with chipset 1402. User interface components 1406 can include a keyboard, a microphone, touch detection, and processing circuitry, and a pointing device, such as a mouse.

Chipset 1402 can also interface with one or more communication interfaces 1408 that can have different physical interfaces. Such communication interfaces can include interfaces for wired and wireless local area networks, for broadband wireless networks, and for personal area networks. Further, the machine can receive inputs from a user via user interface components 1406, and execute appropriate functions, such as browsing functions by interpreting these inputs using processor 1410.

Moreover, chipset 1402 can also communicate with firmware 1412, which can be executed by the computer system 1400 when powering on. The firmware 1412 can recognize, initialize, and test hardware present in the computer system 1400 based on a set of firmware configurations. The firmware 1412 can perform a self-test, such as a POST, on the system 1400. The self-test can test the functionality of the various hardware components 1402-1418. The firmware 1412 can address and allocate an area in the memory 1418 to store an OS. The firmware 1412 can load a boot loader and/or OS, and give control of the system 1400 to the OS. In some cases, the firmware 1412 can communicate with the hardware components 1402-1410 and 1414-1418. Here, the firmware 1412 can communicate with the hardware components 1402-1410 and 1414-1418 through the chipset 1402, and/or through one or more other components. In some cases, the firmware 1412 can communicate directly with the hardware components 1402-1410 and 1414-1418.

It can be appreciated that example systems 1300 (in FIG. 12) and 1400 can have more than one processor (e.g., 1330, 1410), or be part of a group or cluster of computing devices networked together to provide greater processing capability.

As used in this application, the terms “component,” “module,” “system,” or the like, generally refer to a computer-related entity, either hardware (e.g., a circuit), a combination of hardware and software, software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller, as well as the controller, can be a component. One or more components may reside within a process and/or thread of execution, and a component may be localized on one computer and/or distributed between two or more computers. Further, a “device” can come in the form of specially designed hardware, generalized hardware made specialized by the execution of software thereon that enables the hardware to perform specific function, software stored on a computer-readable medium, or a combination thereof.

The terminology used herein is for the purpose of describing particular embodiments only, and is not intended to be limiting of the invention. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof, are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art. Furthermore, terms, such as those defined in commonly used dictionaries, should be interpreted as having a meaning that is consistent with their meaning in the context of the relevant art, and will not be interpreted in an idealized or overly formal sense unless expressly so defined herein.

While various embodiments of the present invention have been described above, it should be understood that they have been presented by way of example only, and not limitation. Although the invention has been illustrated and described with respect to one or more implementations, equivalent alterations and modifications will occur or be known to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application. Thus, the breadth and scope of the present invention should not be limited by any of the above described embodiments. Rather, the scope of the invention should be defined in accordance with the following claims and their equivalents.

What is claimed is:

1. A virtual remote desktop system providing remote devices access to virtual desktops, the virtual desktops consuming compute resources, the system comprising:
a compute resource optimization service communicating with a client on a remote device;
a virtual desktop having an agent in communication with the resource optimization service; and
a virtual infrastructure system in communication with the compute resource optimization service, wherein the compute resource optimization service optimizes allocation of the compute resources to the virtual desktop from the virtual infrastructure system by setting the virtual desktop in one of a plurality of states.

2. The system of claim 1, wherein the plurality of states includes a paused state.

3. The system of claim 2, wherein the paused state includes one of suspending a virtual machine associated with the virtual desktop, powering down the virtual machine or de-allocating the virtual machine.

4. The system of claim 2, wherein the plurality of states further includes a resuming state, a disconnected state, and a connected state.

5. The system of claim 2, wherein the plurality of states includes an error handling state.

6. The system of claim 4, wherein a transition to the pause state from another state occurs via one of explicit logout, explicit disconnect or a protocol idle connection timeout.

7. The system of claim 1, further comprising a storage device storing a policy accessible by the compute resource optimization service, wherein the policy determines the transition to the one of the plurality of states of the virtual desktop in response to events.

8. The system of claim 7, wherein the policy is one of a plurality of policies, each of the plurality of policies determining a different allocation of compute resources to the virtual desktop.

9. The system of claim 7, wherein the virtual desktop is a member of a pool of virtual desktops, and wherein the policy is applied to each virtual desktop in the pool.

10. The system of claim 7, wherein one of the plurality of states is a pause state designated as a normal state for the virtual desktop.

11. The system of claim 7, wherein the policy is a configurable policy allowing the specification of a delay period that follows a disconnection before a pause automatically occurs.

12. The system of claim 7, wherein the policy is a configurable policy allowing the specification of a period of work hours where the virtual desktop is not paused.

13. The system of claim 1, wherein the optimization service includes the capacity to pause the virtual desktop by reallocating the compute resources when the virtual desktop is idle.

14. The system of claim 13, wherein the reallocation of the compute resources is made to at least one other user of another virtual desktop in a different time zone than the user.

15. The system of claim 13, wherein a period of time for pausing the virtual desktop is determined from a previous pattern of use of the virtual desktop by the user.

16. The system of claim 13, wherein a period of time for pausing the virtual desktop is determined from a schedule associated with the user of the virtual desktop.

17. The system of claim 1, wherein the optimization service includes the capacity to resume or reallocate compute resources dedicated to the virtual desktop.

18. The system of claim 1, wherein the virtual desktop is provisioned by the infrastructure system and is initially paused after being provisioned by the infrastructure system.

19. The system of claim 1, wherein the virtual desktop is configurable to be re-connected unless a pause state is determined by the compute resource optimization service.

20. The system of claim 19, wherein if the virtual desktop is in a pause state, feedback is provided to the user of the remote device to indicate a short delay before the virtual machine becomes available.

21. The system of claim 1, wherein the compute resources include at least one of processing or memory provided by the infrastructure system.

22. A virtual remote desktop system providing remote devices access to virtual desktops, the virtual desktops consuming compute resources, the system comprising:
a compute resource optimization service communicating with a client on a remote device;
a virtual desktop having an agent in communication with the resource optimization service; and
a virtual infrastructure system in communication with the compute resource optimization service, wherein the compute resource optimization service optimizes allocation of the compute resources to the virtual desktop from the virtual infrastructure system by setting the virtual desktop in a paused state allowing conservation of the compute resources and a resume state when a user uses the virtual desktop.

23. A method for optimizing processing and/or memory resources for a virtual desktop, the method comprising:
providing a user access to a virtual desktop on a remote device, the virtual desktop having a client consuming compute resources on a virtual infrastructure system, communicating with the client on the remote device via a compute resource optimization service; and
optimizing allocation of the compute resources to the virtual desktop from the virtual infrastructure system via the compute resource optimization service by setting the virtual desktop in one of a plurality of states.
